(19) United States
(12) Patent Application Publication
(10) Pub. No.: US 2011/0211114 A1
(43) Pub. Date: Sep. 1, 2011

(54) METHOD OF ADJUSTING BANDWIDTH USAGE OF REMOTE DISPLAY DEVICES BASED UPON USER PROXIMITY

(75) Inventor: Steven L. Cooper, Whitestown, IN (US)

(73) Assignee: SHENZHEN TCL NEW TECHNOLOGY LTD., Shekou, Shenzhen, Guangdong (CN)

(21) Appl. No.: 13/125,912

(22) PCT Filed: Apr. 3, 2009
(86) PCT No.: PCT/US09/39425

§ 371 Date: Apr. 25, 2011

(30) Foreign Application Priority Data
Nov. 24, 2008 (CN) 200810178409.7

(51) Int. Cl. H04N 7/01

(52) U.S. Cl. 348/441; 348/E07.003

(57) ABSTRACT

An exemplary method of processing video content is provided which allows for adjusting the resolution, bitrate, or other target display characteristic of the video content based on information collected from an electronic device, such as a display device or intermediary electronic component. The exemplary method includes the steps of collecting information from an electronic device, determining a target display characteristic based on the collected information, adjusting the video content based on the target display characteristic, and transmitting the adjusted video content to the electronic device. The collected information may include the viewing distance of a user from a display device, the display area or native resolution of the display device, values from a menu option on the display device, and so forth.

### FIELD OF THE INVENTION

The present invention relates generally to electronic devices. More particularly, the present invention relates to a method and system for adjusting the resolution, bitrate, or other characteristic of video content transmitted to a display device based on characteristics specific to the display device and the users viewing the video content displayed by the display device.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

In a home media server environment, bandwidth may be extremely valuable. For instance, these environments tend to include only the bare necessities for distributing media across a small-scale local network (either wired or wireless). As such, the hardware and cabling used are often selected to fit within a typical household budget. Therefore, the associated bandwidth capability of such networks is not as great as one would expect in certain non-residential settings.

Media servers may transmit their content to many destinations for multiple users. This content is often encoded into a compressed digital format in real time as it is being streamed to one or more receivers. For high definition video content, the compressed version may be very large, up to 10-20 megabits per second. If multiple streams are sent simultaneously, the bandwidth for the typical home media network may be exceeded. This would be especially true if other network activity is proceeding at the same time, such as file transmission, downloading content from the internet, web browsing, and so forth. Therefore, it may be useful, whenever possible, to reduce the size of the content being transmitted.

Many times the video content is transmitted to a display device that is either very small, being viewed at a distance by the user, or both. In these scenarios, the user may not be able to perceive the level of detail being displayed on the device. If this fact could be shared with the transmitter, the encoding could be performed, for instance, at a lower resolution, reducing the bandwidth usage without a perceivable loss of detail for the viewer.

### BRIEF DESCRIPTION OF THE DRAWINGS

These and other features, aspects, and advantages of the present technique will become better understood when the following detailed description is read with reference to the accompanying drawings in which like characters represent like parts throughout the drawings, wherein:

FIG. 1 is a diagram of a media server in accordance with present embodiments;

FIG. 2 is a diagram of a home media server environment in accordance with present embodiments; and

FIG. 3 is a process flow diagram showing a process in accordance with present embodiments.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Video content is often encoded into a compressed digital format in real time as it is streamed to one or more display devices. For high definition video content and the like, the compressed digital format may be very large. Thus, when multiple video streams including such content are sent simultaneously, the bandwidth of a typical home media server environment may be exceeded, especially if other network activity is present. The present techniques address this issue by allowing for adjustment of the resolution, bitrate, and other target display characteristics of the video content based on several factors, including the distance of the user from the display device, the size of the display area on the display device, and other menu options selected by the user.

In many situations, video content may be transmitted to a display device having a small display area. Alternatively, the user may be at a distance from the display device. If either, or both, of these situations occur, the user may not be able to perceive high levels of detail being displayed on the display device. In other words, there may be no benefit to the viewer from providing high levels of detail. Therefore, in accordance with present embodiments, communicating information regarding the display device and the distance of the user from the display device may allow for optimization of the display resolution which may, in turn, lead to reduced bandwidth usage without a perceivable loss of detail for the user. In addition, adjusting the bitrate of the video stream may not impact the viewing experience for the user. For instance, if the user is viewing at a greater distance, the user may not be able to perceive the difference between a video stream being transmitted at 5 megabits per second and a video stream being transmitted at 20 megabits per second.

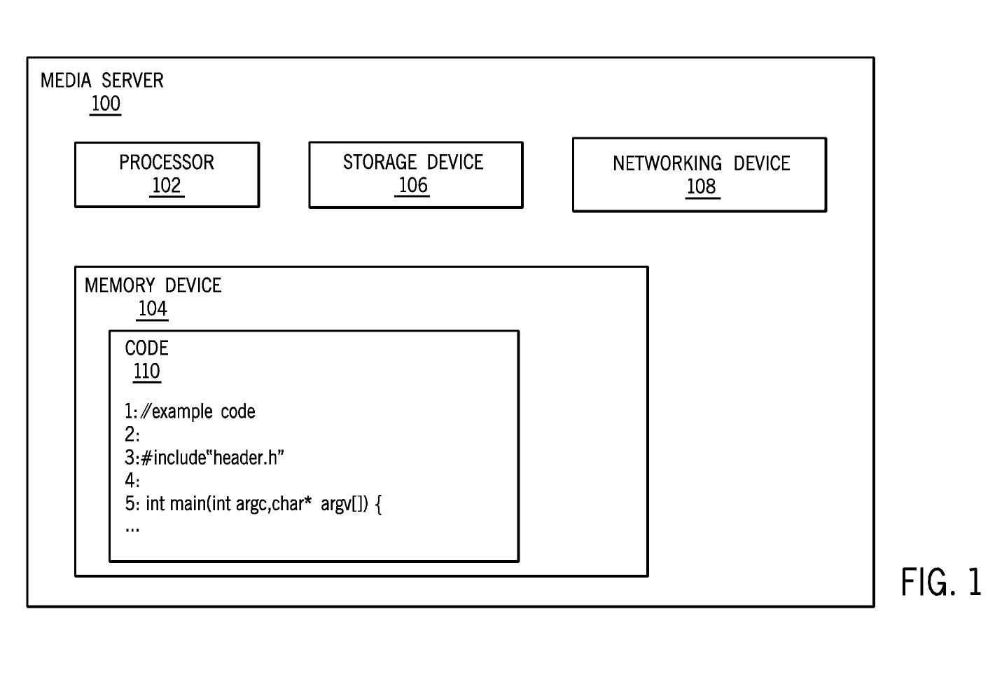

Home media servers may be used as a central location for storing and/or streaming media content (e.g., video, music, photos, and so forth). A media server may be any computer adapted to work as a hub for disseminating media content across an environment. FIG. 1 is a block diagram illustrating various components and features of a media server 100 in accordance with an embodiment. The media server 100 may include a processor 102, a memory device 104, a storage device 106, and a networking device 108.

The processor 102 may provide the processing capability needed to execute instructions relating to operation of the media server 100. The memory device 104 may include a volatile memory, such as random access memory (RAM), a non-volatile memory, such as read-only memory (ROM), or any other suitable tangible machine-readable medium. The memory device 104 may store a variety of information and may be used for various purposes. For example, the memory device 104 may store executable code 110 and instructions for the processor 102. For example, the memory 104 may store machine-readable computer code 110 for receiving and processing information relating to characteristics (e.g., native resolution) of a display device on which media content from the media server 100 will be displayed as well as characteristics (e.g., distance of user from the display device) regarding a viewer of the display device. As discussed in further detail below, the machine-readable computer code 110 may use this information to determine a target display characteristic, such as optimized resolution or bitrate, at which to transmit the media content.

The storage device 106 may include a hard drive, ROM, flash memory, or any other medium suitable for storing media content. The storage device 106 may be used to store the media content which will be disseminated across the home media server environment. In order to transmit the media content across the environment, the media server 100 may also include the networking device 108, which may be a network controller or a network interface card (NIC). In some embodiments, the networking device 108 may be a wireless NIC providing wireless connectivity over any 802.11 standard or other suitable wireless networking standard. The networking device 108 may allow the media server 100 to communicate over a network, such as a local area network (LAN).

As discussed above, the processor 102, memory device 104, and storage device 106 may provide processing capability and storage allowing for a plurality of programs and functions to be executed by the media server 100. These programs and functions may include storage and streaming of media content to display devices in a home media server environment.

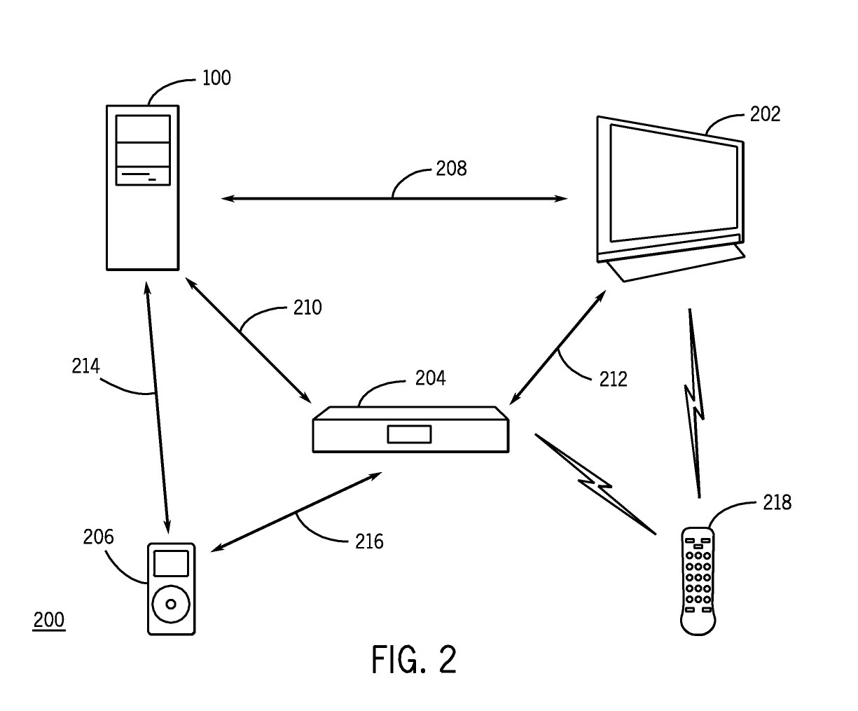

FIG. 2 illustrates a home media server environment in accordance with an embodiment. The home media server environment is generally indicated by reference numeral 200 and may include the media server 100, a non-portable display device 202, an intermediary electronic component 204, and a portable display device 206. The media server 100 may be any suitable computing device configured to store media content and/or stream media content from an external source through a network connection. The media server 100 may be configured to transmit media content to many different components, including the non-portable display device 202, intermediary electronic component 204, and portable display device 206, as illustrated in FIG. 1.

The non-portable display device 202 may include any display device that is not typically moved from place to place on a regular basis. For instance, the non-portable display device 202 may be a television set configured to rest on a support structure, a flat-panel television configured to mount on a wall, a monitor connected to a desktop computer, or any other display device not typically moved around. The media server 100 may be configured to communicate with the non-portable display device 202, as illustrated by reference numeral 208. This communication 208 may be accomplished in a number of ways. For instance, the media server 100 may be directly connected to the non-portable display device 202 via suitable cables, including specifically video-centric cables (e.g., S-video, composite, component, HDMI, DVI, VGA, and so forth) as well as more general-purpose cables (e.g., coaxial, ethernet, optical, USB, and so forth). This communication 208 between the media server 100 and the non-portable display device 202 may also be accomplished wirelessly using suitable wireless technologies between the media server 100 and the non-portable display device 202, such as Bluetooth, IrDA, 802.11, and so forth.

The intermediary electronic component 204 may include any electronic component which is not specifically configured to display media content but, rather, is configured to act as an intermediary between the media server 100 and a display device 202, 206. For instance, the intermediary electronic component 204 may be an audio/visual receiver configured to receive the media content, process an audio portion of the media content, and pass-through (or perhaps process and then pass-through) a video portion of the media content. The media server 100 may be configured to communicate with the intermediary electronic component 204, as illustrated by reference numeral 210, and the intermediary electronic component 204 may be configured to communicate with the non-portable display device 202, as illustrated by reference numeral 212. In a similar manner as discussed above, these communications 210, 212 may be accomplished using either direct connection or wireless communication technologies.

The portable display device 206 may be any electronic device specifically designed to be moved from place to place. For instance, the portable display device 206 may be a portable media player (e.g., iPod®, Zune®, and so forth), a portable gaming system (e.g. Playstation Portable®), or even a video-capable phone (e.g., iPhone®). The media server 100 may be configured to communicate with the portable display device 206, as illustrated by reference numeral 214. In addition, the intermediary electronic component 204 may also be configured to communicate with the portable display device 206, as illustrated by reference numeral 216. In a similar manner as discussed above, these communications 214, 216 may be accomplished using either direct connection or wireless communication technologies. However, due to the inherent portable nature of the portable display device 206, the preferred communication method may likely be wireless communication. However, the portable display device 206 may also be configured to directly communicate with both the media server 100 and the intermediary electronic component 204 such as through a USB or other suitable cable or through the use of a cradle or docking station (not shown).

Regardless of which display device 202, 206 is viewed, the position of the user from the display device is one of the many variables that may be used by the media server 100 to determine how to optimize the resolution, bitrate, and other target display characteristics of the video content. For instance, if the user is at a greater distance from the display device, the resolution of the video content may generally be reduced without a perceivable loss in detail. However, if the user is closer to the display device 202, 206, the resolution may generally need to be higher since the user will be able to perceive details in the video content.

Although the actual distance of the user from the display device may not be ascertainable at any given time because there are no actual sensors on the user, suitable proxies for this distance may be utilized. For instance, when using the non-portable display device 202 and/or the intermediary electronic component 204, a remote controller 218 may often be used in conjunction. As such, it may be possible to approximate the distance of the user from the non-portable display device 202 based on the location of the remote controller 218 from the non-portable display device 202. If the remote controller 218 is used to directly control the non-portable display device 202, the distance from the remote controller 218 to the non-portable display device 202 may be used as an approximate distance of the user from the non-portable display device 202. However, if the remote controller 218 is used to control the intermediary electronic component 204 in order to control video content sent to the non-portable display device 202, the distance from the remote controller 218 to the intermediary electronic component 204 may be used as an approximate distance of the user from the non-portable display device 202. Alternatively, the intermediary electronic component 204 may communicate with the non-portable display device 202 to, in essence, triangulate the distances between the non-portable display device 202, the intermediary electronic component 204, and the remote controller 218. However, in most instances, simply using the distance of the remote controller 218 from the intermediary electronic component 204 may suffice as an approximation of the distance of the user from the non-portable display device 202.

Whenever the remote controller 218 is used to approximate the distance of the user from the non-portable display device 202, several options may be used to determine the distance of the remote controller 218 from the non-portable display device 202. The simplest option may be to determine that the user is “distant” if he is using the remote controller 218 and “near” if he is using the controls located on the device instead. This option has the advantage of being the easiest to implement but it also allows for the lowest level of optimization. For instance, using this option, there would only be two settings—“distant” and “near”—which may be used to optimize the video content.

Another option for determining the distance of the remote controller 218 from the non-portable display device 202 may be to determine the strength of the signal received from the remote controller 218. If the signal is stronger, it may be assumed that the remote controller 218 is closer to the non-portable display device 202 and if the signal is weaker, it may be assumed that the remote controller 218 is further away from the non-portable display device 202. This option may require calibration between the remote controller 218 and the device being controlled. In addition, this option may require that the remote controller 218 transmit its current battery strength to the device being controlled so that the variable nature of the battery strength may be removed from the determination of the signal strength.

Other options for determining the distance of the remote controller 218 from the non-portable display device 202 may include using location sensors and other positioning solutions. For instance, both the non-portable display device 202 and the remote controller 218 may be equipped with global positioning system (GPS) receivers. Alternatively, radio frequency or infrared triangulation between the non-portable display device 202 and remote controller 218 may be employed. In addition, it may be possible to track the locations of the non-portable display device 202 and remote controller 218 using a home security system (e.g., motion detectors). In summation, any suitable technique for tracking the relative location of the non-portable display device 202 and remote controller 218 may be employed to determine the distance between the two.

In fact, any combination of the techniques described above for approximating the distance of the user from the non-portable display device 202 may be used. Furthermore, the present disclosure is not limited to the techniques described above but, rather, encompasses any techniques suitable for establishing the distance of the user from the non-portable display device 202. In addition, these techniques may also be used to determine the distance of the user from the portable display device 206. However, in the case of the portable display device 206, it may be more prudent to simply assume that the user is a short distance away from the portable display device 206. For instance, it may be reasonable to assume the user is holding the portable display device 206 in his hands at a fixed distance from the user's eyes.

In addition, it may also be useful to allow the user to select a value for viewing distance as a menu option on the particular display device being viewed. This selected value may be used to override and/or supplement the viewing distances determined using the techniques described above. This selected viewing distance value, coupled with the viewing distance determined using the techniques described above, may be used by the media server 100 to optimize the video content resolution and bitrate.

Along with the distance of the user from the display device, other variables that may be used by the media server 100 to determine how to optimize the resolution, bitrate, and other target display characteristics of the video content are the size of the display area and the native resolution of the display device being viewed. For instance, if the display area of the display device being viewed is only a 15-inch diagonal widescreen, then for a given user viewing distance, a lower resolution may be possible than for a 60-inch diagonal widescreen. This is because the amount of detail the human eye can perceive is based upon both the size and distance of an object or display. Accordingly, if the size of the display area of the display device is communicated to the media server 100, the media server 100 may be able to determine an appropriate resolution at which to transmit video content based on the distance of the user from the display device.

Similarly, if the native resolution of the display device is communicated to the media server 100, the media server 100 may be capable of reducing the resolution of the video content being transmitted to a value that does not exceed the display device's native resolution. The display resolution, along with the size of the display area and the distance of the user from the display device may provide the media server 100 with the best available information for determining an appropriate minimum resolution and bitrate for encoding and transmission.

Another technique for optimizing the resolution and bitrate of the video content transmitted by the media server 100 may be to provide the user with a sliding scale and allow the user to select a minimum acceptable resolution. The sliding scale may, for instance, be presented to the user as a menu option on the display device. Once the user selects a minimum acceptable resolution, this value may be communicated to the media server 100 from the display device. The user may, for instance, be allowed to save a different setting for different viewing locations such as “distant” or “near.” These settings may also be stored based upon different viewing locations, such as “office,” “deck,” “bedroom,” and so forth. These different viewing locations may be integrated into the viewing distance approximation techniques described in greater detail above. Alternatively, the different viewing locations may simply be presented to the user as a separate menu option on the display device.

All of the operational values discussed above (e.g., viewing distance, characteristics of the display device, and menu options selected by the user) may be communicated to the media server 100 from the display devices 202, 206, the intermediary electronic component 204, or some combination thereof. Once the media server 100 has received this information, the media server 100 may then determine an appropriate resolution and bitrate of the video content to transmit to the display device. The exact methods used by the media server 100 to determine an appropriate resolution may depend upon the particular implementation. However, as discussed above, in general, a greater viewing distance may cause the media server 100 to transmit video content at a lower resolution while a closer viewing distance may cause the media server 100 to transmit video content at a higher resolution. In addition, smaller display areas of the display devices may cause the media server 100 to transmit lower resolutions while larger display areas of the display devices may cause the media server 100 to transmit higher resolutions. Furthermore, the media server 100 may be configured to not transmit video content at resolutions exceeding the native resolution of the display device. However, menu options selected by the user may be used either as overriding values or as supplemental information by the media server 100 in determining an appropriate resolution and bitrate for the video content.

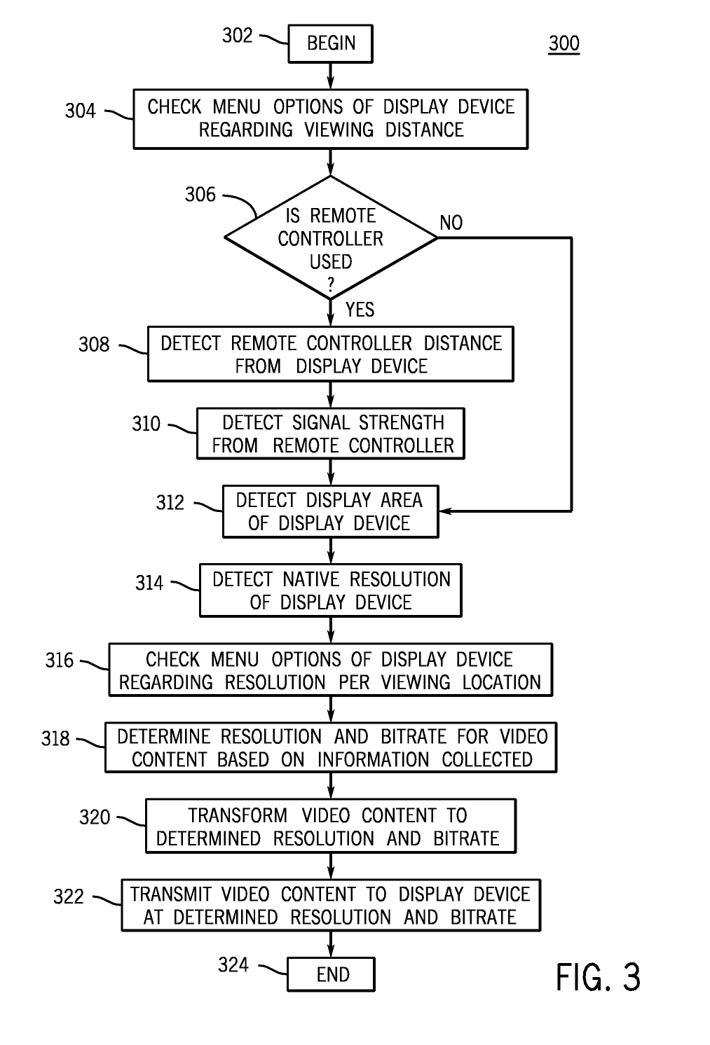

The techniques described above may be consolidated into an integrated process for optimizing the resolution, bitrate, and other target display characteristics of video content transmitted by the media server 100 to a particular display device. FIG. 3 depicts steps in an exemplary process 300 used by the media server 100 to determine an appropriate resolution and bitrate for any particular display device. At block 302, the process 300 begins. At block 304, the media server 100 checks the menu options of the display device to determine if the user has entered a value for the viewing distance.

Then, at block 306, the media server 100 determines whether a remote controller 218 is being used to control either the display device or an intermediary electronic component 204 is being used to route video content to the display device. If a remote controller 218 is being used, at block 308, the media server 100 detects how far the remote controller 218 is from the display device using any of the techniques described in detail above. In addition, the media server 100 detects the signal strength from the remote controller 218 to the device being controlled, as represented by block 310. Both of these values may be used by the media server 100 to approximate the distance between the user and the display device.

The media server 100 then detects the display area and native resolution of the display device, as represented by blocks 312 and 314. In addition, at block 316, the media server 100 checks the menu options of the display device to determine if the user has entered a value for the preferred resolution at a particular viewing location. Once the media server 100 gathers all this information, the media server 100 determines an appropriate resolution and bitrate for video content to be transmitted to the display device, as represented by block 318. Next, at block 320, the media server 100 transforms the video content from a first format to a second format such as by encoding the video content at the determined resolution or bitrate. Then, the media server 100 transmits the video content to the display device at the determined resolution and bitrate, as represented by block 322. Finally, the process 300 ends at block 324.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method of processing video content, comprising:
collecting information from an electronic device;
determining a target display characteristic based on the collected information;
adjusting the video content based on the target display characteristic; and
transmitting the adjusted video content to the electronic device.

2. The method of claim 1, wherein the electronic device is a display device.

3. The method of claim 1, wherein the electronic device is an intermediary electronic component.

4. The method of claim 1, wherein collecting the information comprises determining an estimated viewing distance of a user from the electronic device.

5. The method of claim 4, wherein determining the estimated viewing distance comprises accessing a menu option on the electronic device selected by the user.

6. The method of claim 4, wherein determining the estimated viewing distance comprises determining the location of a remote controller relative to the electronic device.

7. The method of claim 4, wherein determining the estimated viewing distance comprises determining the strength of a signal generated by a remote controller.

8. The method of claim 1, wherein collecting the information comprises determining a size of a display area of the electronic device.

9. The method of claim 1, wherein collecting the information comprises determining a native resolution of the electronic device.

10. The method of claim 1, wherein collecting the information comprises determining a resolution value selected by a user as a menu option on the electronic device.

11. The method of claim 1, wherein the target display characteristic is a resolution value for the video content.

12. The method of claim 1, wherein the target display characteristic is a bitrate value for the video content.

13. A home media system, comprising:
a storage device configured to store video content;
a memory device configured to store machine-readable computer code configured to transform the video content based on an operational value of the home media system;
a networking device configured to transmit the transformed video content;
a display device configured to receive and display the transformed video content; and
a processor configured to control operation of the storage device, memory device, and networking device.

14. The system of claim 13, wherein the operational value is an estimated distance between the display device and a user.

15. The system of claim 13, wherein the operational value is a characteristic of the display device.

16. The system of claim 13, wherein the operational value is a menu option value selected by a user.

17. The system of claim 13, comprising an intermediary electronic component configured to receive and transmit the transformed video content.

18. A tangible machine-readable medium, comprising:
first instructions stored on the tangible machine-readable medium, the first instructions adapted to receive video content in a first format;
second instructions stored on the tangible machine-readable medium, the second instructions adapted to transform the video content from the first format to a second format based on a characteristic of a display device; and
third instructions stored on the tangible machine-readable medium, the third instructions adapted to transmit the video content in the second format to the display device.

19. The tangible machine-readable medium of claim 18, wherein the second instructions are adapted to transform the video content from the first format to the second format by encoding the video content at a specific resolution.

20. The tangible machine-readable medium of claim 18, wherein the second instructions are adapted to transform the video content from the first format to the second format by encoding the video content at a specific bitrate.
